(19) United States
(12) Patent Application Publication
(10) Pub. No.: US 2015/0265987 A1
(43) Pub. Date: Sep. 24, 2015

(54) THERMOSTATIC FAN CLUTCH FOR BLENDER NOISE REDUCTION AND MOTOR EFFICIENCY IMPROVEMENT

(71) Applicant: VITA-MIX CORPORATION, Olmsted Township, OH (US)

(72) Inventor: James Edward Kidd, Willoughby, OH (US)

(21) Appl. No.: 14/662,549

(22) Filed: Mar. 19, 2015

Related U.S. Application Data
(60) Provisional application No. 61/968,136, filed on Mar. 20, 2014.

(51) Int. Cl. B01F 15/00; G05D 23/01

(52) U.S. Cl. CPC B01F 15/00538; G05D 23/01

(57) ABSTRACT

A blending apparatus includes a motor, a fan, and a thermostatic fan clutch. The fan is engaged with a secondary drive shaft of the motor and the thermostatic fan clutch engages the secondary drive shaft to cause the fan to rotate and disengages the secondary drive shaft to cause the fan to stop rotating. The thermostatic fan clutch also partially engages and/or partially disengages the secondary drive shaft to cause the fan to rotate at a controlled speed or an adjusted speed. In addition, the thermostatic fan clutch engages and/or disengages the secondary drive shaft based on a temperature of the motor.

### CROSS-REFERENCE TO RELATED APPLICATION

This application claims priority to U.S. Provisional Application Ser. No. 61/968,136, filed on Mar. 20, 2014, entitled “THERMOSTATIC FAN CLUTCH FOR BLENDER NOISE REDUCTION AND MOTOR EFFICIENCY IMPROVEMENT”, the entirety of which is incorporated herein by reference.

### FIELD

This disclosure relates to a fan clutch for a household appliance. More particularly, the disclosure relates to a thermostatic fan clutch for a blending apparatus to provide noise reduction and to improve motor efficiency.

### BACKGROUND

Blenders and other household appliances typically include an electric motor to convert electrical energy into mechanical energy to operate features of the appliance. When in operation, the motor generates heat which can increase the temperature of the motor and its surroundings. To help regulate the temperature of the motor, a fan is typically included in the appliance to provide a forced air flow to cool the motor. The fan is connected to the motor such that when the motor operates so too does the fan. As a result, the fan spins constantly and rapidly when the motor is in operation. There are, however, several drawbacks associated with a constant, rapidly spinning fan. For example, particularly when spinning at high speeds, the fan and the moving air associated therewith create excessive noise. The excessive noise can be irritating to the user and, likewise, undesirable in a household or commercial environment, such as a kitchen or restaurant. Further, a constant, rapidly spinning fan consumes motor power when the motor is operating, irrespective of the temperature of the motor. Accordingly, the fan introduces unnecessary inefficiencies into the operation of the blender or other household appliance.

### SUMMARY

The following presents a simplified summary of the disclosure in order to provide a basic understanding of some example aspects described in the detailed description. A blending apparatus includes a motor, a fan, and a thermostatic fan clutch. The fan is engaged with a secondary drive shaft of the motor and the thermostatic fan clutch engages the secondary drive shaft to cause the fan to rotate and disengages the secondary drive shaft to cause the fan to stop rotating. The thermostatic fan clutch also partially engages and/or partially disengages the secondary drive shaft to cause the fan to rotate at a controlled speed or an adjusted speed. In addition, the thermostatic fan clutch engages and/or disengages the secondary drive shaft based on a temperature of the motor. In some examples, the thermostatic fan clutch can include at least one of a bi-metallic coil, a fluid, and a mechanical engagement to engage, disengage, partially engage, and/or partially disengage the secondary drive shaft to cause the fan to rotate, stop rotating, and/or rotate at a controlled speed or an adjusted speed.

### BRIEF DESCRIPTION OF THE DRAWING FIGURES

The above and other features, aspects and advantages of the present invention are better understood when the following detailed description of the invention is read with reference to the accompanying drawings, in which:

FIG. 1 illustrates a blending apparatus including a thermostatic fan clutch in accordance with examples of the disclosure.

### DETAILED DESCRIPTION

The following presents a description of the disclosure; however, aspects may be embodied in many different forms and should not be construed as limited to the embodiments set forth herein. Furthermore, the following examples may be provided alone or in combination with one or any combination of the examples discussed herein.

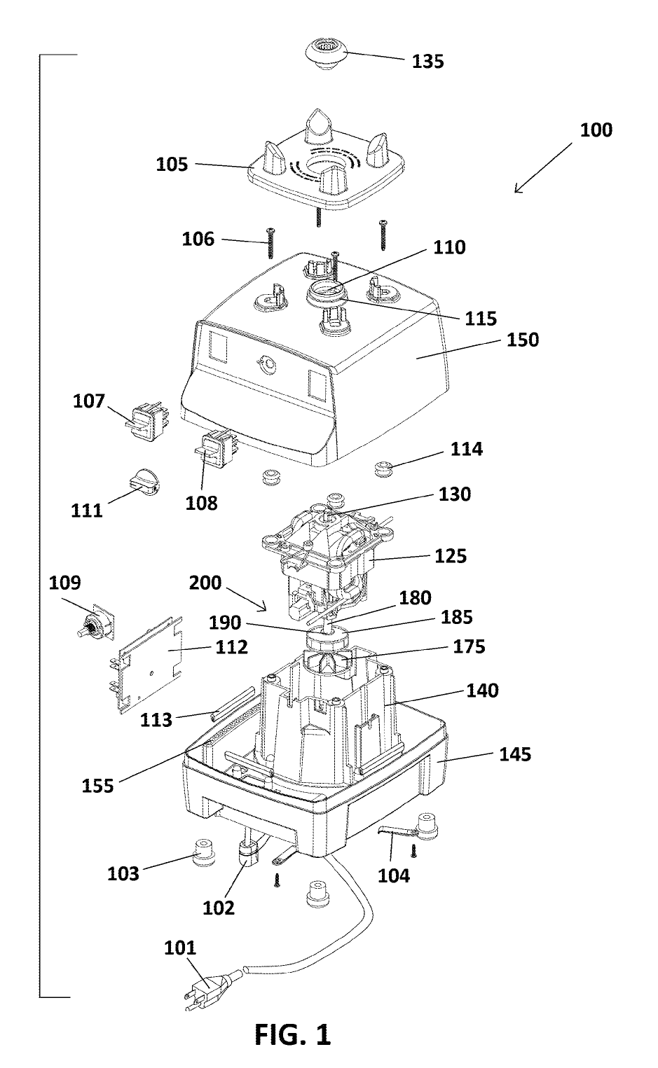

The present disclosure relates to a thermostatic fan clutch for a blending apparatus or other household appliance. As shown in FIG. 1, a blending apparatus 100 comprises a motor 125 (e.g. an electric motor) for operating one or more features of the blending apparatus 100. In one example, the motor 125 operates to rotate a primary drive shaft 130. The primary drive shaft 130 rotates an axial shaft or spindle (not shown) of the blending apparatus 100 for processing items to be blended. The primary drive shaft 130 can include a motor drive coupling 135 configured to couple the primary drive shaft 130 of the motor 125 to the axial shaft of the blending apparatus 100. The axial shaft can include a blending blade (not shown) for processing items to be blended. The blending blade can include a plurality of radially extending blades configured to blend food or other items to be blended in the blending apparatus 100. The blending apparatus 100 can further comprise a container (not shown) for receiving and holding the items to be processed, pulverized, blended, or otherwise mixed, therein.

The blending apparatus 100 can also include a power cord 101 configured to connect to a power source (not shown) to provide electricity to the motor 125 to operate the motor 125. The power cord 101 can include a power cord strain relief coupling 102 configured to support the power cord 101 and at least one power cord retainer clip 104 configured to hold or store the power cord 101 underneath the blending apparatus 100. The blending apparatus 100 can further include a rotary switch 109 connected to a speed control circuit board 112. The rotary switch 109 can include a control knob 111 by which a user can control a speed of the motor 125. In addition, the blending apparatus 100 can include a high/low switch 107 configured to control a power level of the motor 125 and an on/off switch 108 configured to turn the motor 125 on and off.

In another example, the motor 125 is arranged in a housing assembly 140. The housing assembly 140 can include a base frame 145 and a cover 150. The housing assembly 140, base frame 145, and cover 150 can comprise apertures 155 formed therein, including air intake apertures and air exit apertures through which air can enter and exit the housing assembly 140, respectively. The base frame 145 can include feet 103 (e.g. rubber feet) configured to elevate the base frame 145 above a surface on which the blending apparatus 100 is positioned. At least one base frame channel 113 can be used to position the cover 150 onto the base frame 145. In addition, a centering pad 105 can be attached to the cover 150 with a plurality of retainer screws 106 which can connect to the housing assembly 140 with at least one bushing 114 therebetween for providing a mounting surface on which the container can be selectively or operatively engaged. In still another example, the motor 125 can be positioned on a pedestal (not shown) located in the housing assembly 140. The primary drive shaft 130 of the motor 125 and/or the axial shaft of the blending apparatus 100 can extend through an aperture 110 formed in a bearing housing 115 to connect to the blending blade in the container.

In another example, a fan 175, such as a rotary fan, a squirrel cage fan, or any other fan, is arranged in the housing assembly 140. For instance, the fan 175 can be arranged below the motor 125 in a base portion of the housing assembly 140. The fan 175 is configured to draw ambient air from the surroundings to cool the motor 125. In particular, the fan 175 can spin to draw ambient air in through the air intake apertures of the housing assembly 140 and to further force that air at, over, around, or near the motor 125. The air can regulate a temperature of the motor 125 and/or decrease a temperature of the motor 125. In another example, the fan can be arranged in a muffling housing (e.g. housing assembly 140) configured to reduce or dampen noise generated by the fan 175 and the motor 125. The motor 125 is configured to drive or rotate the fan 175. The fan 175 can be directly attached to a secondary drive shaft 180 of the motor 125 such that the fan 175 spins based on the rotation of the secondary drive shaft 180 of the motor 125. In another example, the motor 125 is configured to drive the fan via a mechanical connection. For instance, a belt or other mechanical linkage (not shown) can connect the motor 125 and the fan 175 such that the motor 125 operates to drive or rotate the fan 175 through the mechanical connection.

In another exemplary embodiment of the disclosure, the blending apparatus 100 can include a fan clutch 185 that engages and/or disengages the motor 125 from operating to rotate the fan 175. For example, when the fan clutch 185 can engage the motor 125 (e.g. through the secondary drive shaft 180) such that the motor 125 operates to rotate the fan 175. On the other hand, when the fan clutch 185 is disengaged, the motor 125 does not operate to rotate the fan (e.g. the secondary drive shaft 180 may still rotate, but because the fan clutch 185 is disengaged, the fan 175 does not rotate). In another example, the fan clutch 185 can partially engage and/or partially disengage the motor 125 (e.g. the secondary drive shaft 180) from operating to rotate the fan 175. For instance, the fan clutch 185 can be configured to control and/or adjust a speed at which the fan 175 rotates. The fan clutch 185 can be configured to integrate with the motor 125, and/or the mechanical connection, and/or the fan 175 to engage and/or disengage the motor 125 from operating to rotate the fan 175 as well as to control and/or adjust the speed at which the fan 175 rotates.

In another example, the motor 125 can simultaneously operate one or more features of the blending apparatus 100 while the fan clutch 185 is engaged and/or disengaged. In particular, the motor 125 can rotate the primary drive shaft 130 of the blending apparatus 100 to rotate the blending blade and can also rotate the secondary drive shaft 180 to rotate the fan 175. In another example, the motor 125 can rotate the secondary drive shaft 180 and the fan 175 only. In still another example, the motor 125 can rotate the primary drive shaft 130 and the blending blade only.

The motor 125 can also operate a feature of the blending apparatus 100 while the fan clutch 185 is engaged, such as fully engaged, to cause the fan 175 to rotate. In particular, the motor 125 can operate a feature of the blending apparatus 100 while the fan clutch 185 is disengaged, such as fully disengaged, to cause the fan 175 to stop rotating. In still another example, the motor 125 can operate a feature of the blending apparatus 100 while the fan clutch 185 is partially engaged to cause the fan 175 to rotate at a controlled and/or adjusted speed. In yet another example, the motor 125 can operate a feature of the blending apparatus 100 while the fan clutch 185 is partially disengaged to cause the fan 175 to rotate at a controlled and/or adjusted speed. For instance, if the motor 125 operates a feature of the blending apparatus 100 (e.g. the blending blade) for a short period of time, it may not be necessary to engage the fan clutch 185 to rotate the fan 175 to cool the motor 125. Further, if the motor 125 operates a feature of the blending apparatus 100 (e.g. the blending blade) for a short period of time, it may be desirable to partially engage the fan clutch 185 to rotate the fan 175 at a controlled and/or adjusted speed to cool the motor 125. Still further, if the motor 125 operates a feature of the blending apparatus 100 (e.g. the blending blade) for a long period of time, it may be desirable to engage, such as fully engage, the fan clutch 185 to rotate the fan 175 to cool the motor 125.

The blending apparatus 100 can further comprise a thermostatic device 190, such as a thermostat or other component configured to sense a temperature of the blending apparatus 100 and/or its surroundings. In one example, the thermostatic device 190 is configured to sense a temperature of the motor 125. The thermostatic device 190 can be configured to control the fan clutch 185. For example, the thermostatic device 190 can be configured to control the engagement and/or disengagement of the fan clutch 185. In one instance, the fan clutch 185 comprises the thermostatic device 190, such that the fan clutch 185 is a thermostatic fan clutch 200. The thermostatic fan clutch 200 can include at least one of a bi-metallic coil configured to respond to changes in temperature and thereby cause the thermostatic fan clutch 200 to engage and/or disengage the secondary drive shaft 180 to cause the fan 175 to rotate. In other examples, the thermostatic fan clutch 200 can include a viscous fluid or a mechanical engagement to engage and/or disengage the secondary drive shaft 180 to cause the fan 175 to rotate or stop rotating.

According to one example, the motor 125 can operate a feature of the blending apparatus 100 while the thermostatic fan clutch 200 is engaged, such as fully engaged, to cause the fan 175 to rotate. In another example, the motor 125 can operate a feature of the blending apparatus 100 (e.g. the blending blade) while the thermostatic fan clutch 200 is disengaged, such as fully disengaged, to cause the fan 175 to stop rotating. In still another example, the motor 125 can operate a feature of the blending apparatus 100 (e.g. the blending blade) while the thermostatic fan clutch 200 is partially engaged to cause the fan 175 to rotate at a controlled and/or adjusted speed. In yet another example, the motor 125 can operate a feature of the blending apparatus 100 (e.g. the blending blade) while the thermostatic fan clutch 200 is partially disengaged to cause the fan 175 to rotate at a controlled and/or adjusted speed.

In another example embodiment, the thermostatic fan clutch 200 can engage and/or disengage the fan 175 based on a temperature of the motor 125 as sensed by the thermostatic fan clutch 200 (e.g. any one or more of the at least one of a bi-metallic coil, a fluid, and a mechanical engagement). For instance, if the thermostatic fan clutch 200 senses that the motor 125 is at or above an engagement temperature, the thermostatic fan clutch 200 can engage, such as fully engage, the secondary drive shaft 180 to cause the fan 175 to rotate to cool the motor 125. In another example, if the thermostatic fan clutch senses that the motor is at or below a disengagement temperature, the thermostatic fan clutch 200 can disengage, such as fully disengage, the secondary drive shaft 180 to cause the fan 175 to stop rotating. In one example, the engagement temperature and/or the disengagement temperature can include a temperature range.

In another example, if the thermostatic fan clutch 200 senses that the motor 125 is at or above a partial-engagement temperature, the thermostatic fan clutch 200 can partially engage the secondary drive shaft 180 to cause the fan 175 to rotate at a controlled and/or adjusted speed to cool the motor 125. In another example, if the thermostatic fan clutch 200 senses that the motor 125 is at or below a partial-disengagement temperature, the thermostatic fan clutch 200 can partially disengage the secondary drive shaft 180 to cause the fan 175 rotate at a controlled and/or adjusted speed. In one example, the partial-engagement temperature and/or the partial-disengagement temperature can include a temperature range.

Accordingly, the thermostatic fan clutch 200 of the present disclosure can reduce excessive air noise by engaging, such as fully engaging and/or partially engaging, the secondary drive shaft 180 to rotate the fan 175 and/or to rotate the fan 175 at a controlled and/or adjusted speed to cool the motor 125 when the motor 125 is at or above a temperature at which cooling thereof is required. Likewise, the thermostatic fan clutch 200 of the present disclosure can reduce excessive air noise by disengaging, such as fully disengaging and/or partially disengaging, the secondary drive shaft 180 to stop the fan 175 from rotating and/or to rotate the fan 175 at a controlled and/or adjusted speed when the motor 125 is at or below a temperature at which cooling thereof is not required. The thermostatic fan clutch 200 of the present disclosure, thus, improves the efficiency of the blending apparatus 100 by consuming motor power to operate to rotate the fan 175 to cool the motor 125 when cooling thereof is necessary or desired.

It will be apparent to those skilled in the art that various modifications and variations can be made without departing from the spirit and scope of the claimed invention.

What is claimed is:

1. A blending apparatus comprising: a motor, a fan, and a thermostatic fan clutch.

2. The blending apparatus of claim 1, wherein the fan is engaged with a secondary drive shaft of the motor and wherein the thermostatic fan clutch engages the secondary drive shaft to cause the fan to rotate.

3. The blending apparatus of claim 1, wherein the fan is engaged with a secondary drive shaft of the motor and wherein the thermostatic fan clutch disengages the secondary drive shaft to cause the fan to stop rotating.

4. The blending apparatus of claim 1, wherein the fan is engaged with a secondary drive shaft of the motor and wherein the thermostatic fan clutch partially engages the secondary drive shaft to cause the fan to rotate at a controlled speed or an adjusted speed.

5. The blending apparatus of claim 1, wherein the fan is engaged with a secondary drive shaft of the motor and wherein the thermostatic fan clutch partially disengages the secondary drive shaft to cause the fan to rotate at a controlled speed or an adjusted speed.

6. The blending apparatus of claim 1, wherein the fan is engaged with a secondary drive shaft of the motor and wherein the thermostatic fan clutch engages or disengages or both engages and disengages the secondary drive shaft based on a temperature of the motor.

7. The blending apparatus of claim 6, wherein the thermostatic fan clutch engages the secondary drive shaft to cause the fan to rotate if the motor is determined to be at or above an engagement temperature.

8. The blending apparatus of claim 6, wherein the thermostatic fan clutch disengages the secondary drive shaft to cause the fan to stop rotating if the temperature of the motor is determined to be at or below a disengagement temperature.

9. The blending apparatus of claim 6, wherein the thermostatic fan clutch partially engages the secondary drive shaft to cause the fan to rotate at a controlled speed or an adjusted speed if the temperature of the motor exhibits or exceeds a predetermined partial-engagement temperature.

10. The blending apparatus of claim 6, wherein the thermostatic fan clutch partially disengages the secondary drive shaft to cause the fan to rotate at a controlled speed or an adjusted speed if the temperature of the motor exhibits or falls below a predetermined partial-disengagement temperature.

11. The blending apparatus of claim 1, wherein the thermostatic fan clutch comprises at least one of a bi-metallic coil, a fluid, and a mechanical engagement to engage, disengage, or both engage and disengage a secondary drive shaft of the motor to cause the fan to at least one of rotate and stop rotating.

12. The blending apparatus of claim 11, wherein the at least one of a bi-metallic coil, a fluid, and a mechanical engagement engages, disengages or both engages and disengages the secondary drive shaft based on a temperature of the motor.

13. The blending apparatus of claim 12, wherein the at least one of a bi-metallic coil, a fluid, and a mechanical engagement engages the secondary drive shaft to cause the fan to rotate if the motor is at or above an engagement temperature.

14. The blending apparatus of claim 12, wherein the at least one of a bi-metallic coil, a fluid, and a mechanical engagement disengages the secondary drive shaft to cause the fan to stop rotating if the motor is at or below a disengagement temperature.

15. The blending apparatus of claim 11, wherein the at least one of a bi-metallic coil, a fluid, and a mechanical engagement partially engages, partially disengages, or both partially engages and disengages the secondary drive shaft of the motor to cause the fan to rotate at a controlled speed or an adjusted speed.

16. The blending apparatus of claim 15, wherein the at least one of a bi-metallic coil, a fluid, and a mechanical engagement partially engages the secondary drive shaft to cause the fan to rotate at a controlled speed or an adjusted speed if the motor is at or above a partial-engagement temperature.

17. The blending apparatus of claim 15, wherein the at least one of a bi-metallic coil, a fluid, and a mechanical engagement partially disengages the secondary drive shaft to cause the fan to rotate at a controlled speed or an adjusted speed if the motor is at or below a partial-disengagement temperature.

18. A blending apparatus comprising: a motor, a fan, and a thermostatic fan clutch, wherein the thermostatic fan clutch engages, disengages, or both engages and disengages a secondary drive shaft of the motor to cause the fan to rotate or stop rotating or both, and wherein the thermostatic fan clutch engages, disengages, or both engages and disengages the secondary drive shaft based on a temperature of the motor.

19. The blending apparatus of claim 18, wherein the thermostatic fan clutch comprises at least one of a bi-metallic coil, a fluid, and a mechanical engagement, wherein the at least one of a bi-metallic coil, a fluid, and a mechanical engagement engages and/or disengages the secondary drive shaft to cause the fan to rotate or stop rotating, and wherein the at least one of a bi-metallic coil, a fluid, and a mechanical engagement engages, disengages, or both engages and disengages the secondary drive shaft based on a temperature of the motor.

20. The blending apparatus of claim 18, wherein the thermostatic fan clutch comprises at least one of a bi-metallic coil, a fluid, and a mechanical engagement, wherein the at least one of a bi-metallic coil, a fluid, and a mechanical engagement partially engages, partially disengages, or both partially engages and disengages the secondary drive shaft to cause the fan to rotate at a controlled speed or an adjusted speed, and wherein the at least one of a bi-metallic coil, a fluid, and a mechanical engagement partially engages, partially disengages, or both partially engages and disengages the secondary drive shaft based on a temperature of the motor.
